(19) United States
(12) Patent Application Publication
(10) Pub. No.: US 2011/0055030 A1
(43) Pub. Date: Mar. 3, 2011

(54) Point of Sale System for Communicating Marketing Messages Based on a Sales Transaction

(75) Inventors: Pascal Nicolas, Round Rock, TX (US); Michael Lee, Austin, TX (US)

(73) Assignee: SALESVU, LLC, Round Rock, TX (US)

(21) Appl. No.: 12/870,688

(22) Filed: Aug. 27, 2010

Related U.S. Application Data
(60) Provisional application No. 61/238,857, filed on Sep. 1, 2009.

(51) Int. Cl. G06Q 30/00; G06Q 99/00

(52) U.S. Cl. 705/16; 705/319

(57) ABSTRACT

A method, POS system, and computer program product is provided for integrating a POS system with social networking platforms. A Point Of Sale (POS) system obtains sales information associated with a sales transaction. After acquiring a customer's authorization to use his/her e-mail address information, the POS system reconciles the sales information with marketing data. The POS system packages marketing information based on the sales information acquired and communicates the marketing information associated with the sales transaction to a social networking platform to which the customer is a subscriber.

### PRIOR APPLICATION DATA

The present application claims priority to U.S. Provisional Patent Application 61/238,857 filed Sep. 1, 2009, and entitled “BANK INTEGRATED POINT OF SALE SYSTEM,” the contents of which are incorporated herein by reference in its entirety.

This application is also related to U.S. application Ser. No. 12/xxx,xxx filed on even date herewith, and entitled “POINT OF SALE SYSTEM FOR RECONCILING POINT OF SALE AND FINANCIAL INFORMATION,” and Utility application Ser. No. 12/xxx,xxx filed on even date herewith, and entitled “POINT OF SALE SYSTEM FOR RECONCILING SALES INFORMATION WITH A SALES INCENTIVE,” all of which are incorporated herein for all purposes.

### BACKGROUND OF THE INVENTION

1. Technical Field

The present invention relates in general to Point-Of-Sale (POS) systems, and more particularly to networked POS systems.

2. Description of the Related Art

Most retailers conduct consumer transactions using electronic Point-Of-Sale (POS) systems. Modern POS systems typically have a desktop computer, a touch screen monitor, a cash drawer, a receipt printer, a bar code scanner, and a Magnetic Strip Reader (MSR) to process credit card transactions. Some systems, referred to as “all-in-one” POS solutions, incorporate a computer, monitor, and MSR into a single device. Multiple POS terminals at one location can be linked to a single, on-site server, which aggregates transactions from the terminals to ensure that all POS terminals are in synch.

These computer based POS systems are an improvement over the previous generation of cash registers because they not only allow cashiers to process transactions, but also facilitate control of inventory, employee hours, customer loyalty programs, and time based discounts.

Various patents have been issued for various POS system functionality, including: U.S. Pat. No. 5,484,988, which describes a POS system that transfers funds from a customer's bank account to the store's bank account when the customer tenders a check for payment; U.S. Pat. No. 7,344,069, which describes a distributed POS system that allows interaction between POS terminals; and U.S. patent application Ser. No. 10/977,078, which describes a system that allows information about product inventory stored in a POS system to be exported over the Internet for customers to search.

The usefulness of conventional POS systems, however, resides with recording sales information. Consequently, these POS systems do not allow their users to fully tap into the marketing/advertising potential that follows from each POS purchase. In view of the foregoing, conventional POS systems are less than perfect.

### SUMMARY OF THE INVENTION

A method according to at least one embodiment includes obtaining, using a Point Of Sale (POS) system, sales information associated with a sales transaction. In various embodiments, sales information includes the type and quantity of the products/services sold, the sales cost of the products/services, any savings associated with the sale, and customer identifying data (e.g., an e-mail address associated with the purchaser of the products/services). With the customer's authorization to use his/her social network identifier, a POS system communicates marketing information associated with the sales transaction to a social networking platform, wherein the marketing information is communicated to an account of a customer associated with the sales transaction.

In various embodiments, the communicating step includes first sending the sales information from a POS terminal unit to a central server, and then sending the marketing information associated with the sales transaction to the social networking platform to which the customer is associated to be publicly exposed. In various embodiments, once the POS system has obtained a customer's initial authorization to publish marketing information at the customer's social networking platform, any subsequent marketing information for subsequent purchases is communicated automatically to the social networking platform. In various embodiments, marketing information includes information identifying a product or service associated with the sales transaction, but without identifying a retailer of the product or service. In other embodiments, marketing information includes information identifying the retailer of a product or service associated with the sales transaction, but without identifying the product or service. In other embodiments, the marketing information includes a link to a retailer, manufacturer, product, or service associated with the customer's sales transaction.

Various embodiments may take the form of a system including a processor, memory, a communications interface to obtain sales information associated with a sales transaction, and a program of instructions to implement any of the various methods described herein.

Moreover, various embodiments may take the form of a computer program product including a computer-usable storage medium and computer executable instructions on the computer-usable storage medium that when executed by a processor of a computer and/or a communication device provides the functions in the various methods described herein.

### BRIEF DESCRIPTION OF THE DRAWINGS

Aspects of this disclosure will become apparent upon reading the following detailed description and upon reference to the accompanying drawings, in which like references may indicate similar elements:

FIG. 1 is a diagram illustrating a Point Of Sale (POS) system according to various embodiments of the present disclosure;

FIG. 2 is a block diagram of a server and its various components according to embodiments of the present disclosure;

FIG. 3 is a high-level logical flow chart of an exemplary method of remotely obtaining a financial report, according to an embodiment of the present disclosure;

FIG. 4 is a high-level logical flow chart of an exemplary method of remotely obtaining revenue extrapolation data based on the use of a sale incentive in a sales transactions, according to an embodiment of the present disclosure;

FIG. 5 is a high-level logical flow chart of an exemplary method of communicating marketing information based on a customer's sales transaction to a social networking platform, according to an embodiment of the present disclosure; and

FIG. 6 is a high-level block diagram of a processing system according to an embodiment of the present disclosure.

### DETAILED DESCRIPTION OF ILLUSTRATIVE EMBODIMENT

Aspects of this disclosure will become apparent upon reading the following detailed description and upon reference to the accompanying drawings, in which like references may indicate similar elements:

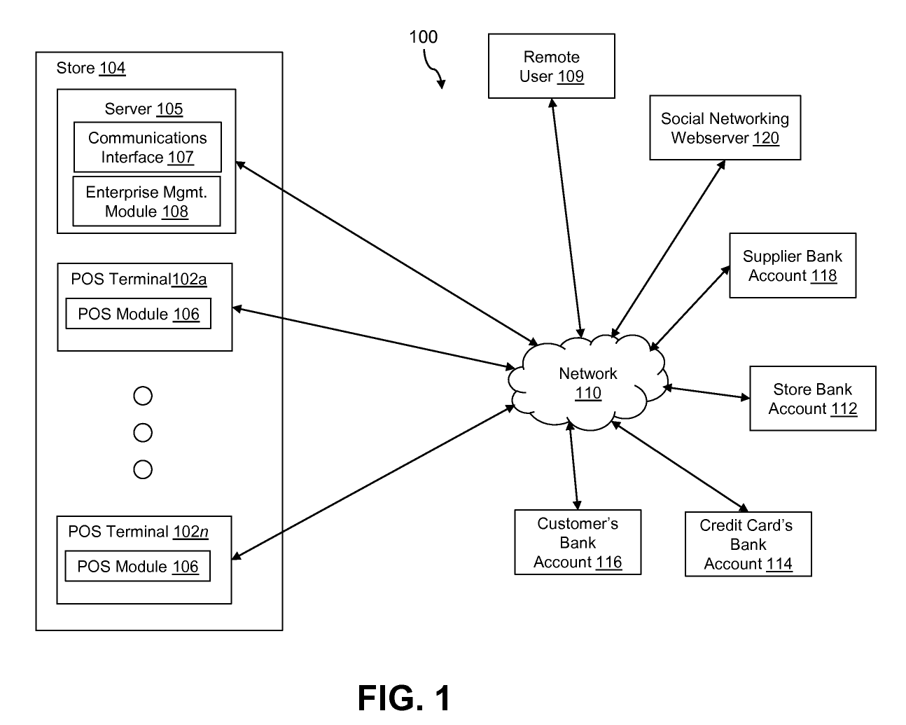

FIG. 1 is a diagram illustrating a Point Of Sale (POS) system according to various embodiments of the present disclosure;

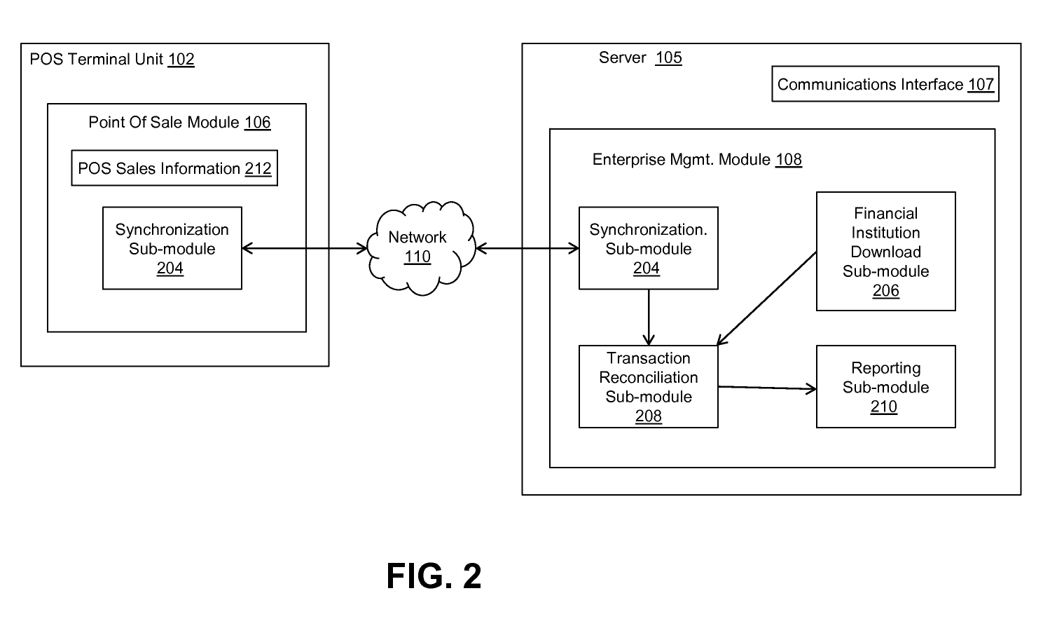

FIG. 2 is a block diagram of a server and its various components according to embodiments of the present disclosure;

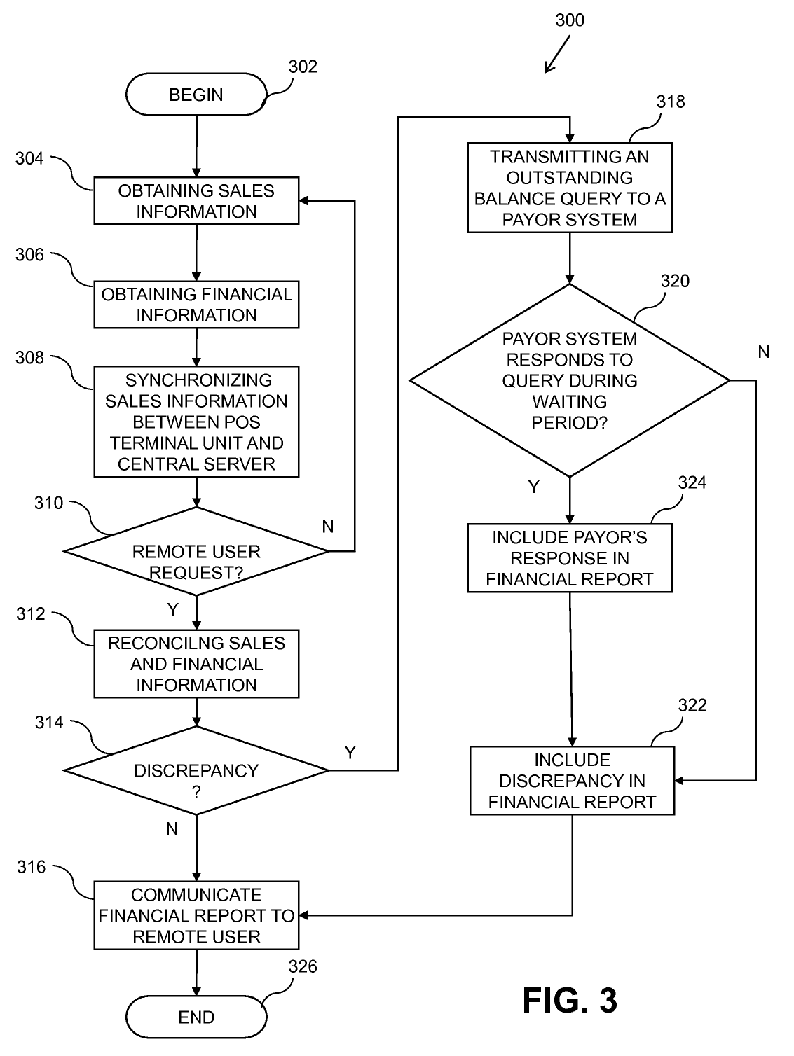

FIG. 3 is a high-level logical flow chart of an exemplary method of remotely obtaining a financial report, according to an embodiment of the present disclosure;

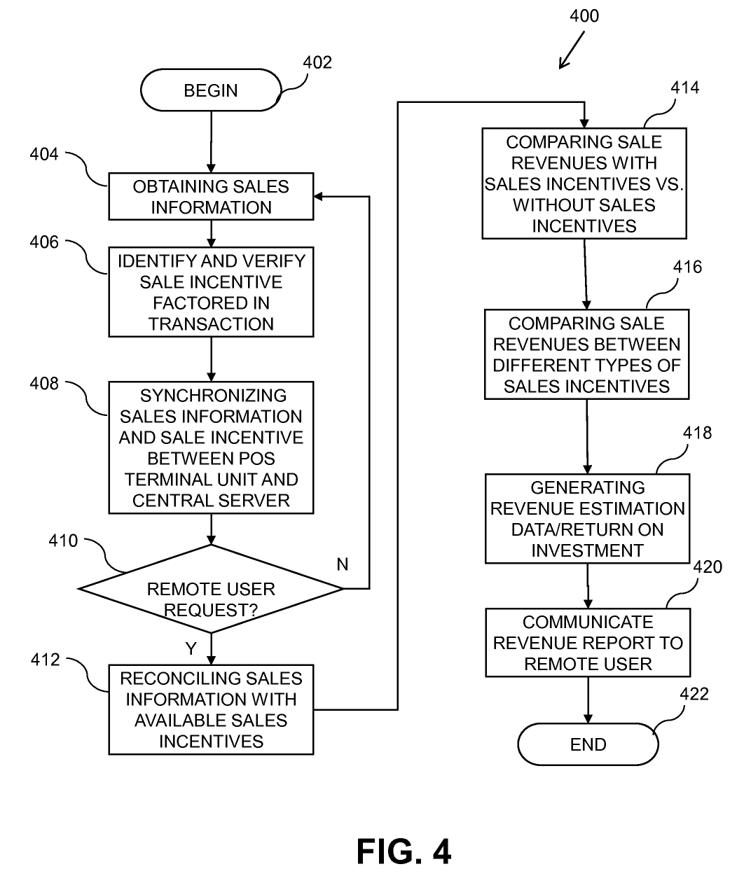

FIG. 4 is a high-level logical flow chart of an exemplary method of remotely obtaining revenue extrapolation data based on the use of a sale incentive in a sales transactions, according to an embodiment of the present disclosure;

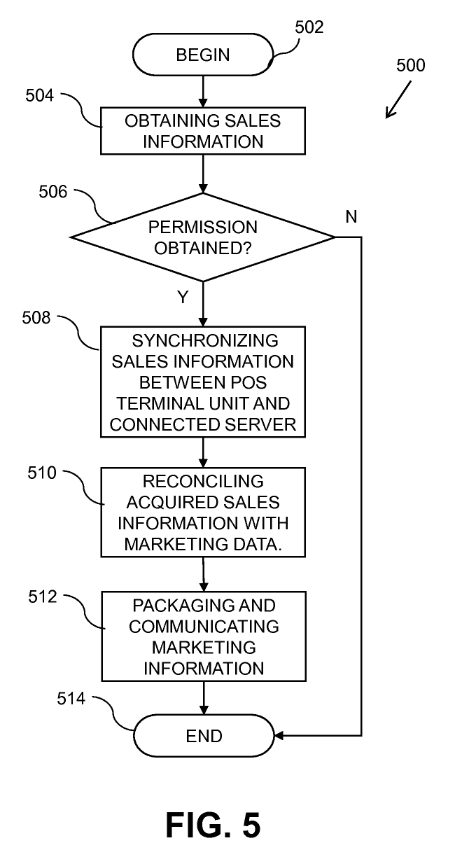

FIG. 5 is a high-level logical flow chart of an exemplary method of communicating marketing information based on a customer's sales transaction to a social networking platform, according to an embodiment of the present disclosure; and

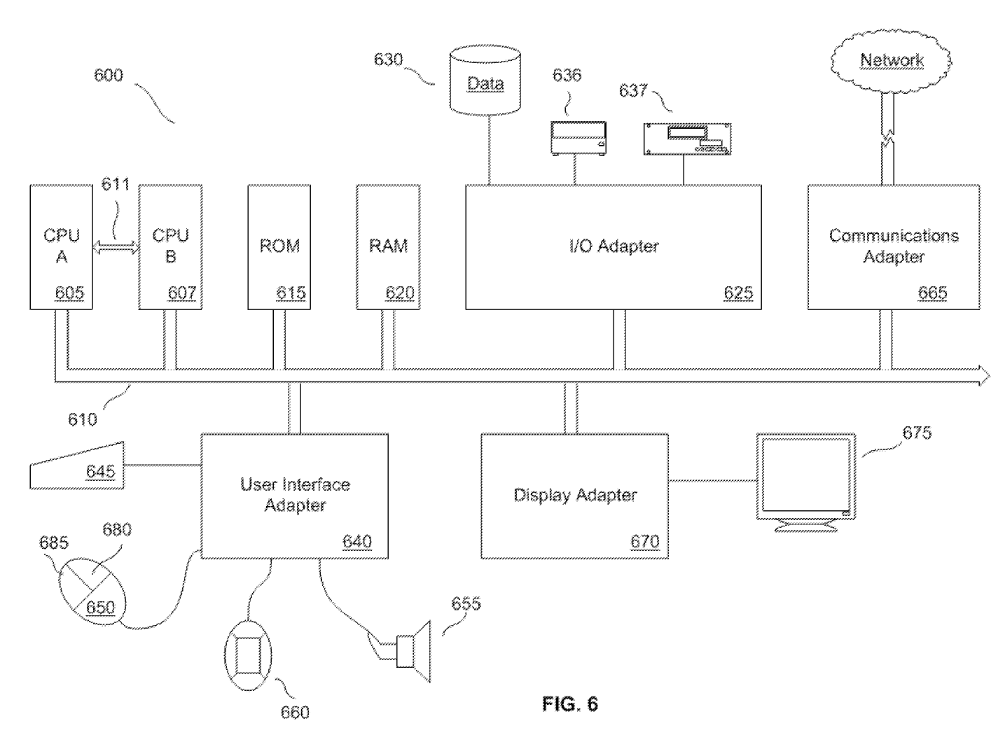

FIG. 6 is a high-level block diagram of a processing system according to an embodiment of the present disclosure.

### DETAILED DESCRIPTION OF ILLUSTRATIVE EMBODIMENT

The following is a description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Referring to FIG. 1, a Point Of Sale (POS) system 100 according to various embodiments of the present disclosure will be discussed. POS system 100 can include one or more Point Of Sale terminal(s) 102a-n situated in various locations of a store 104, and a server in communication with those terminals. POS software/module 106 resides in POS terminal(s) 102a-n. Enterprise Management software/module 108 resides on one or more server(s) 105, which in at least one embodiment are part of a POS system. Although software 106, 108 are hosted by store 104 according to this embodiment, the invention is not limited in this regard and such software can be hosted remotely by a third party provider, such as SalesVu LLC. Remote users 109 (e.g., store owners) can login to a web page (for example, www.SalesVu.com) via network 110 (e.g., Internet, Intranet, VPN) to access a POS connected server and manage their POS software remotely, and quickly see how the POS sales transactions reconcile with actual deposits/withdrawals made to/from a store bank account 112 residing at a bank server. In other embodiments, the POS software can also be managed directly from any of the POS terminal(s) 102a-n.

For example, deposits made to the store bank account include payments from a payor's bank account (e.g., credit card company's bank account 114) after a customer's credit card transaction has been initially approved at the time of the POS transaction. In another example, deposits by a payor can take the form of electronic payments via network 110 from a customer's bank account 116 to the store's bank account 112, as in the case of debit card or check transactions. Withdrawals from a store bank account 112 usually occur when the store owes payment to its supplier (e.g., payable to supplier's bank account 118) or when a product has been returned to the store and the monies are credited back to either the credit card company's bank account 114 or the customer's own bank account 116.

In some embodiments, the POS module 106 running at store 104 can include sub-modules for transactions processing, employee management, and inventory management. In addition to these POS sub-modules, embodiments of the POS software described herein can include a synchronization sub-module that allows the local POS terminal(s) 102a-n to securely synchronize with server 105 and other POS terminal(s) 102a-n throughout the store 104 at regular intervals. In some embodiments, the type of information that is synchronized between each POS terminal 102a-n, and between each POS terminal 102a-n and server 105 includes sales information generated in conjunction with a sales transaction at POS terminal 102a-n. In some embodiments, sales information includes information associated with one or more POS terminal(s) 102a-n. Sales information includes, but is not limited to, a sale amount/price, the method of payment used (i.e., cash, check, debit card, or credit card), sale incentives (e.g., sale coupons (if any)), the date and time of the transaction, an identifier associated with POS terminal 102a-n, and any customer identifiers (i.e., frequent shopper number, e-mail address, name, telephone number, and the like). The sales information collected from the various POS terminal 102a-n is thus consolidated at server 105 and/or each POS terminal 102a-n and matched and reconciled with financial information. According to some embodiments, the financial information includes a deposit amount and a date of deposit, and a deposit type. Examples include bank transactions between various bank accounts 112, 114, 116, and/or 118.

Various user preferences and settings, or automatic timing features or the like, can be used to control the transmission of information to server 105 and each POS terminal 102a-n. For example, in some instances, remote user 109 may want fewer than all of the POS terminal 102a-n to send sales information to server 105 and the other POS terminals 102a-n. In other implementations, even if all POS terminals 102a-n synchronize their sales information, they may do so at various times, using various different periods of transmission. Furthermore, in some embodiments, transmission to server 105 and the other POS terminals 102a-n can be stopped or started manually, based on network usage, based on control signals from server 105 and/or other POS terminals 102a-n, or based on other suitable input.

Additionally, in some embodiments, only some of the information from a particular POS terminal 102a-n may be delivered to server 105 and other POS terminals 102a-n. According to other embodiments, a POS terminal 102a-n can, for example, send some types of information to server 105 and the other POS terminals 102a-n on a daily schedule, while sending additional types of information on a monthly or quarterly schedule if so desired.

Referring now to FIG. 2, embodiments of an Enterprise Management module 202 residing within server 105 are discussed. It should be noted that in other embodiments where a server 105 is not employed, the Enterprise Management module 108 can reside in one of the POS terminals 102a-n, or be distributed among multiple POS terminals. In some embodiments such as the embodiment illustrated in FIG. 2, Enterprise Management module 108 can be implemented in four sub-modules: a POS Synchronization sub-module 204, a Financial Institution Download sub-module 206, a Transaction Reconciliation sub-module 208, and a Reporting sub-module 210.

The Synchronization sub-module 204 (residing also in POS module 106) can be used as an interface between POS module 106 residing within the various POS terminals 102a-n and the Enterprise Management module 108 residing within server 105. POS sales information 212 that is collected by POS module 106 can be transmitted to Enterprise Management module 202 of server 105 via network 110 (e.g., a secure web service connection). In at least one embodiment, using the Hypertext Transfer Protocol (HTTP) protocol, POS Synchronization sub-module 204 will synchronize data between POS terminal 102 and server 105 through a Secure Sockets Layer (SSL) encrypted connection. Nevertheless, it should be recognized that the invention is not limited to employing HTTP and SSL encryption. In this regard, various embodiments can be implemented using other suitable security protocols and procedures, including username and password protection and various data encryption techniques. For example, in some embodiments, public or private key encryption techniques complying with various U.S. and European banking regulations can be implemented to ensure protected transfer of sensitive information.

At least one embodiment also incorporates an automated accounting feature that can reconcile all bank transactions with sales transactions made using the POS system 100. Server 105 can be configured to interface, via communications interface 107, with a common framework (e.g., third party or custom developed) to retrieve financial information associated with POS terminal(s) 102a-n from a financial institution coupled to communications interface 107. The retrieval of financial information is achieved using Financial Institution Download sub-module 206. However, the invention is not limited in this regard and other embodiments lacking a server 105 in its POS system architecture may instead employ POS terminals 102a-n to obtain such financial information. According to the embodiment shown in FIG. 1, server 105 can use a secure HTTP Simple Object Access Protocol (SOAP) protocol to retrieve all necessary financial information via this common framework. Even though at least one embodiment is implemented using a common framework, the invention disclosed herein should not be considered to be limited to the exclusive use of a common framework. For example, a third party entity could be used to provide the necessary financial information. Communications protocols and standards are constantly evolving, and the teachings set forth herein can be adapted to incorporate other communication and security protocols, and either standard or non-standard changes to existing protocols, without departing from the spirit and scope of the present disclosure.

The latest synchronized POS sales information 212 associated with a sales transaction at a POS terminal 102 can be compared against financial information retrieved by server 105 using Transaction Reconciliation sub-module 208. Transaction Reconciliation sub-module 208 will then proceed to match all sales transactions made at POS terminal(s) 102a-n and record any discrepancies (e.g., store sale payment(s) that remain outstanding). Sales transactions that are successfully reconciled can be presented to the remote user 109, along with any discrepancies, via Reporting sub-module 210.

For example, a financial report generated by server 105 can be provided to remote user 109 via a web page that shows information about deposits and withdrawals. In some embodiments, a Deposit section of the financial report shows how much money should be deposited in the store's bank account for each day of operation. This data is included as POS sales information 212 obtained from sales transactions that were retrieved from some or all of a store's POS terminals 102, as described in the previous paragraph. Furthermore, the POS sales information 212 obtained from POS terminal(s) 102a-n can be separated into individual amounts of money to be deposited in the form of Cash, Check, Debit Card, and Credit Card (further separated by credit card company) payments. The Deposit section of the financial report can also be used to show how much money was actually deposited during any given time period (e.g., day, week, month, quarter, etc.), as well as any discrepancies between money amounts that should have been deposited and money amounts that were actually deposited in the store's bank account (i.e., reflecting accounts receivable). These discrepancies can be determined by comparing, for example, the financial information regarding actual bank deposits with the sales information regarding the previous day's expected deposits. In some embodiments, if the matching of data indicates that expected deposits are greater than actual deposits, then the discrepancy will be indicated in a Discrepancy section of the financial report, also referred to as an Accounts Receivable section.

On the revenue side of the financial report, the above associated Discrepancy section can be used to automate the process that store owners currently use to reconcile all the money that came in to the business through the POS terminals (i.e., sales information) with the money deposited in the store's bank account (i.e., financial information). This approach can greatly reduce bookkeeping fees, provide peace of mind, and reduce the possibility of theft or misplacement of funds.

On the expense side of the financial report, purchase order (PO) amounts for POs are generated (also deemed “sales information” for purposes of this embodiment) using POS system 100 to authorize the purchase of goods or services from suppliers. The expense side of the financial report also reflects the money amounts actually withdrawn from the payor's bank account (e.g., store bank account 112) (i.e., via check, debit card, or any other payment method) to pay the supplier (also deemed “financial information” for purposes of this embodiment). The money paid to the supplier is deposited at the supplier's bank account 118. According to other embodiments where a server 105 is not employed in POS system 100, discrepancies between PO amounts and actual amounts withdrawn from the payor's bank account, also referred to as “accounts payable”, can also be reported using a POS terminal 102. The Accounts Payable section of the generated financial report can help store owners manage their cash flow by automatically keeping track of exactly how much money is owed to suppliers at any given time. Discrepancies, which are often a major concern for store owners, can be shown in the financial report until manually reconciled or removed.

In addition to detecting and reporting discrepancies to remote user 109, POS system 100 communicates an outstanding balance query to a payor system, such as a bank-related system or credit-related system, if Transaction Reconciliation sub-module 208 determines that the sales information is not reconciled with the financial information. In the event of an Accounts Receivable discrepancy, the outstanding balance query communicates the fact that money has not been deposited in store's bank account 112 and seeks to inquire from the payor system when the owed money is to be paid, according to one embodiment. In the event of an Accounts Payable discrepancy, the outstanding balance query sent by POS system 100 seeks to allay any concerns of a supplier or a credit card company regarding the store's outstanding debt to the supplier or credit card company.

Referring now to FIG. 3, a method 300 is discussed according to various embodiments of the present disclosure discussed earlier with reference to FIGS. 1 and 2. Method 300 commences at block 302 and continues to block 304, which depicts obtaining POS sales information 212 generated in conjunction with a sales transaction at POS terminal 102a-n, via communications interface 107 (FIGS. 1 and 2) coupled to POS terminal 102a-n. As illustrated by block 306, server 105 obtains financial information associated with POS terminal 102a-n via communications interface 107 (which includes financial institution download sub-module 206) coupled to a financial institution. As illustrated by block 308, POS synchronization sub-module 204 synchronizes POS sales information 212 between POS terminal unit 102 and server 105.

As shown in decision block 310, POS system 100 determines whether it has received a report query from a remote user 109. If a report query has not been received, the method iteratively returns to block 304, where the method continues to update the sales and financial information until a report query is received. If a report query has been received, the method continues to block 312, which depicts server 105 reconciling the most current POS sales information 212 with the financial information to determine whether funds associated with the sales transactions have been deposited with the financial institution. As part of the reconciliation, server 105 determines an association between financial information and a particular one of POS terminals 102a-n. In particular, this includes matching (i) a deposit amount with a sale price, (ii) a transaction date with a date of deposit, and (iii) a method of payment with a deposit type. From block 312, the method continues to decision block 314, which depicts server 105 determining whether a discrepancy exists between the sales and financial information that have been reconciled. According to some embodiments, this includes identifying, at server 105, a pattern of irregularities between sales information generated at the particular one of POS terminals 102a-n and associated financial information obtained from the financial institution. If no discrepancy exists, reporting sub-module 210 communicates a report informing the remote user that there are no discrepancies, as depicted in block 316. However, if a discrepancy exists (i.e., the POS sales information is not fully reconciled with the financial information), reporting sub-module transmits an outstanding balance query to a payor system, as depicted in block 318. As illustrated by decision block 320, a determination is made whether the payor system has responded to the outstanding balance query within a predetermined period of time. If no response is received within a predetermined period, reporting sub-module 210 includes the discrepancy in its report to remote user, as depicted in block 322. If a response is received within the predetermined period, reporting sub-module 210, reporting sub-module 210 includes the response (block 324) along with the discrepancy (block 322) in the financial report. From block 322, the method proceeds to block 316, which depicts the communication of the financial report to the remote user and the method ends at termination block 326.

### Sales Incentive Reconciliation

In addition to POS system 100 communicating financial report data based on the reconciliation of POS sales transactions with financial transactions, POS system 100 can also generate revenue data based on the reconciliation of POS sales transactions that are associated with the use of a sales incentive, for example a coupon. As used herein, the terms “coupon” and “sales incentive” are used in a broad sense, and include not only traditional print coupons, but also electronic, audio, video, and other coupons, offers, incentives, and related marketing tools that can be used to provide an incentivize to purchase goods or services.

According to some embodiments, such sales incentives can include, for example, store or manufacturer coupons in any of various forms or formats. For example, a coupon may take the form of a previously generated unique code delivered for display on a customer's handheld device such as a gaming device, telephone, personal digital assistant, laptop, or the like. In some such embodiments, the code can be delivered to a portable device with a display screen, and the screen can be scanned in much the same way as the barcode on a conventional paper coupon is scanned. In other embodiments, the unique code can be delivered to a customer and manually entered by either the customer or an attendant operating the POS system at which the coupon is redeemed. In some embodiments, the code can even take the form of an audible or tactile code that can be read or interpreted by a suitable input device providing input to the POS system.

Moreover in some embodiments, the sales incentives can represent coupons for a monetary or percentage reduction, while in other cases the sales incentive may represent other types of incentives (e.g., “buy one get one free”). Referring to FIG. 1, coupons can be identified and factored into sales transactions involving the POS terminal unit(s) 102a-n. The sales incentive data is synchronized, along with other sales information with central server 105, where the data is then reconciled and analyzed for future reporting to a remote user.

With reference now to FIG. 4, a method 400 is discussed according to various embodiments of the present disclosure discussed earlier with reference to FIGS. 1 and 2. Method 400 commences at block 402 and continues to block 404, which depicts POS system 100 (FIG. 1) obtaining POS sales information 212 associated with a sales transaction. According to some embodiments, sales information 212 represents a revenue value associated with the sales transaction. As illustrated by block 406, POS system 100 identifies and verifies a sale incentive factored in one or more sales transactions, using POS module 106 (FIG. 2). As used herein, the terms “factor,” “factored,” factoring,” and the like, refer to something being “taken into account.” By way of a non-limiting example, when a sales incentive is “factored in” to a sales transaction the sales incentive is employed/redeemed to alter an initial sales amount of a sales transaction to reflect a new sales amount of the sales transaction. The verification performed at block 406 can include, in some embodiments, obtaining a previously generated unique code from a customer. The code can include a bar code, alphanumeric code, picture, or the like, displayed on a display screen and scanned into the POS system using any of various scanning mechanisms known to those of ordinary skill in the art.

As illustrated by block 408, POS synchronization sub-module 204 synchronizes the sale incentive and POS sales information 212 to central server 105. While the present embodiment synchronizes to a central server for future reconciliation, the invention is not limited in this regard and the synchronization may occur between POS terminal units 102a-n in embodiments where a central server 105 is not employed for reconciling the data.

As shown in decision block 410 POS system 100 determines whether it has received a report query from a remote user 109. If a report query has not been received, the method iteratively returns to block 404, where method 400 continues to update the sales information and sales incentive data until a report query is received. If a report query has been received, the method continues to block 412, which depicts POS system 100 reconciling the most current POS sales information 412 with sales incentives (if any, to determine an amount of revenue attributable to the sales incentive).

According to some embodiments, the reconciliation is performed by Transaction Reconciliation sub-module 208. From block 412 the method proceeds to block 414, which depicts Transaction Reconciliation sub-module 208 comparing during a predetermined time period: (i) sale revenue for a product without the use of the sale incentive and (ii) sale revenue for the product with the use of the sale incentive. This comparison provides not only valuable information as to the effects that coupons may have on overall revenues, but it also provides the effects that coupons may have on ancillary sales. As illustrated by block 416, Transaction Reconciliation sub-module 208 also compares during a predetermined time period: (i) sale revenue that factors a first type of sale incentive and (ii) sale revenue factoring a second type of sale incentive. This type of comparison allows a retailer or manufacturer to analyze the effects that different types of coupons may have on sale revenues for a particular product and/or for overall sale revenues.

From block 416, the method continues to block 418, which depicts Reporting sub-module 210 generating revenue estimation data based on the reconciliation and comparison steps described in blocks 412, 414, and 416. According to some embodiments, the revenue estimation data includes a return on investment (ROI), a total expected revenue during a predetermined time period, an average expected revenue per sales transaction, and an average expected revenue per sales transaction that have factored a coupon or other type of sales incentive. From block 418, the method proceeds to block 420, which depicts Reporting sub-module 210 communicating to remote user 109 the revenue report that includes the revenue estimation data requested by the remote user. The method ends at termination block 422.

### Integration of POS System and Social Networking Applications

Aside from analyzing and reporting reconciled sales, revenue, and financial information, POS System 100 can enable a retailer or manufacturer to market its goods/services via a customer's social networking platform. The marketing information that is published is associated with a sales transaction to which a customer/social networking subscriber is a party. The POS terminal(s) 102a-n collects and marketing information is generated based on the POS sales information 212 obtained. The marketing information can then be communicated to a social networking site's webserver 120 (FIG. 1), where it is published on the customer's social networking page.

In some embodiments, the marketing information is sent to a user's social networking account on a platform that does not include a social networking site's webserver. For example, the social networking platform may be implemented using a personal device possessed by the user rather than being implemented using a webserver. Regardless of whether the information is sent to a user's account on a webserver belonging to a social networking site, or whether the information is sent to social network platform implemented in some other fashion, the information sent to the user's account can be published for public exposure in a way that allows the user's contacts, friends, or other individuals having access, to see the information posted, published, or otherwise communicated by a POS system.

With reference now to FIG. 5, a method 500 is discussed according to various embodiments of the present disclosure previously described with reference to FIGS. 1 and 2. Method 500 begins at block 502 and continues to block 504, which depicts POS system 100 (FIG. 1) obtaining POS sales information 212 associated with a sales transaction. In some embodiments, the POS sales information 212 is effectuated at a POS terminal 102a-n. According to some embodiments discussed earlier, POS sales information includes, but is not limited to, a sale amount/price, the method of payment used (i.e., cash, check, debit card, or credit card), sale incentives (e.g., sale coupons (if any)), the date and time of the transaction, an identifier associated with the POS terminal 102a-n, any customer identifiers (i.e., frequent shopper number, e-mail address, name, telephone number, and the like), and any customer privacy preferences.

With regard to the acquisition of customer identifier information, a POS terminal may direct a sales agent to ask the customer for such data, including a user's social networking identifier. In other embodiments, the customer identifier information may be previously acquired and stored from a prior sales transaction or registration process. For example, a sales agent may ask the customer for their telephone number on record or frequent shopper card, which when entered into the POS terminal, retrieves a previously stored e-mail address associated with the customer. Moreover, according to other embodiments, if the retailer has established a marketing relationship with a social networking site, such as Facebook, MySpace, LinkedIn, Twitter, and the like, the user's social network identifier may include an account number, password, or other information may allow the retailer or manufacturer access to publish marketing messages associated with sales transactions effectuated by the customer/social networking subscriber.

From block 504, the method continues to decision block 506, which determines whether a POS system 100 has obtained authorization to use a customer's network identifier to access and publish marketing information to a customer's social networking platform, page, site, etc. If no authorization is received, the method ends at block 514. However, if customer authorization is received, the method continues to block 508, which depicts POS synchronization sub-module 204 synchronizing POS sales information 212 to server 105. While the present embodiment synchronizes to a server from which future transmittal of marketing information to a social networking platform is effectuated, the invention is not limited in this regard and the synchronization may occur between POS terminals 102a-n in embodiments where a server 105 is not employed for the communication of marketing information. In some such cases, the POS terminal(s) would be responsible for the packaging and transmittal of the marketing information.

As illustrated by block 510, Transaction Reconciliation sub-module 208 reconciles the acquired sales information (including customer privacy preferences) with marketing/advertising data. As illustrated by block 512, Reporting sub-module 210 packages and communicates the marketing information to social networking webserver 120. Recall that other platforms not involving the use of webservers can also be used. According to some embodiments, the content of the marketing information that is communicated can vary depending on a customer's privacy preferences and/or a store's privacy policies. In various embodiments, marketing information includes information identifying a product or service associated with the sales transaction, but without identifying a retailer of the product or service. In other embodiments, marketing information includes information identifying the retailer of a product or service associated with the sales transaction, but without identifying the product or service. In other embodiments, the marketing information includes a link to a retailer, manufacturer, product, or service associated with the customer's sales transaction. From block 512, the method ends at termination block 514.

Some or all of the methods and processes described herein can be embodied in or performed by one or more processing systems. An example of such a processing system is discussed with reference to FIG. 6. Processing system 600 includes random access memory (RAM) 620; read-only memory (ROM) 615, wherein the ROM 615 could also be erasable programmable read-only memory (EPROM); and input/output (I/O) adapter 625, for connecting peripheral devices such as disk units 630, optical drive 636, or tape drive 637 to system bus 610; a user interface adapter 640 for connecting keyboard 645, mouse 650, speaker 655, microphone 660, or other user interface devices to system bus 610; communications adapter 665 for connecting processing system 600 to an information network such as the Internet or any of various local area networks, wide area networks, telephone networks, or the like; and display adapter 670 for connecting system bus 610 to a display device such as monitor 675. Mouse 650 has a series of buttons 680, 685 and may be used to control a cursor shown on monitor 675.

It will be understood that processing system 600 may include other suitable data processing systems without departing from the scope of the present disclosure. For example, processing system 600 may include bulk storage and cache memories, which provide temporary storage of at least some program code in order to reduce the number of times code must be retrieved from bulk storage during execution.

Various disclosed embodiments can be implemented in hardware, software, or a combination containing both hardware and software elements. In one or more embodiments, the invention is implemented in software, which includes, but is not limited to firmware, resident software, microcode, etc. Some embodiments may be realized as a computer program product, and may be implemented as a computer-usable or computer-readable medium embodying program code for use by, or in connection with, a computer, a processor, or other suitable instruction execution system.

For purposes of this description, a computer-usable or computer readable medium can be any apparatus that can contain, store, communicate, or transport the program for use by or in connection with an instruction execution system, apparatus, or device. By way of example, and not limitation, computer readable media may comprise any of various types of computer storage media, including volatile and non-volatile, removable and non-removable media implemented in any suitable method or technology for storage of information such as computer readable instructions, data structures, program modules, or other data. Computer storage media include, but are not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other tangible medium which can be used to store the desired information and which can be accessed by a computer.

Various embodiments have been described herein. Other variations and modifications of the embodiments disclosed may be made based on the description provided, without departing from the scope of the invention as set forth in the following claims.

What is claimed is:

1. A method comprising:
obtaining, using a Point Of Sale (POS) system, sales information associated with a sales transaction; and
communicating, using said POS system, marketing information associated with said sales transaction to a social networking platform, wherein the marketing information is communicated to an account of a customer associated with the sales transaction.

2. The method of claim 1, said method further comprising:
obtaining a customer's social network identifier.

3. The method of claim 1, wherein said communicating step includes:
sending said sales information from a POS terminal unit to a central server, and
sending said marketing information associated with said sales transaction to said social networking platform to be publicly exposed.

4. The method of claim 1, said method further comprising:
obtaining initial customer authorization prior to said communicating step, wherein after obtaining said initial customer authorization subsequent marketing information is communicated automatically.

5. The method of claim 1, wherein said marketing information includes information identifying a product or service associated with said sales transaction.

6. The method of claim 1, wherein said marketing information includes information identifying a retailer associated with said sales transaction.

7. The method of claim 1, wherein said marketing information includes a link to a retailer associated with said sales transaction.

8. A system comprising:
a processor;
memory operably associated with said processor;
a communications interface coupled to said memory and said processor, said communications interface to obtain sales information associated with a sales transaction;
a program of instructions configured to be stored in said memory and executed by said processor, the program of instructions comprising at least one instruction to communicate marketing information associated with said sales transaction to a social networking platform, wherein the marketing information is communicated to an account of a customer associated with the sales transaction.

9. The system of claim 8, wherein the program of instructions further comprises obtaining a customer's social network identifier.

10. The system of claim 8, wherein said instruction for communicating includes:
sending said sales information from a POS terminal unit to a central server, and
sending said marketing information associated with said sales transaction to said social networking platform to be publicly exposed.

11. The system of claim 8, wherein the program of instructions further comprises:
obtaining initial customer authorization prior to said communicating instruction; and
after obtaining said initial customer authorization, communicating subsequent marketing information to said social networking platform without obtaining subsequent customer authorization.

12. The system of claim 8, wherein said marketing information includes information identifying a product or service associated with said sales transaction.

13. The system of claim 8, wherein said marketing information includes information identifying the retailer.

14. The system of claim 8, wherein said marketing information includes a link to a retailer associated with said sales transaction.

15. A computer program product comprising:
a computer-usable storage medium; and
computer executable instructions on said computer-usable storage medium that when executed by a processor of a computer and/or a communication device provides the functions of:
obtaining sales information associated with a sales transaction; and
communicating marketing information associated with said sales transaction to a social networking platform, wherein the marketing information is communicated to an account of a customer associated with the sales transaction.

16. The computer program product of claim 15, wherein said computer executable instructions comprises an instruction for obtaining a customer's social network identifier.

17. The computer program product of claim 15, wherein said computer executable instruction for communicating comprises instructions for:
sending said sales information from a POS terminal unit to a central server, and
sending said marketing information associated with said sales transaction to said social networking platform to be publicly exposed.

18. The computer program product of claim 15, wherein said computer executable instructions comprises instructions for:
obtaining initial customer authorization prior to said communicating instruction; and
after obtaining said initial customer authorization, communicating subsequent marketing information to said social networking platform without obtaining subsequent customer authorization.

19. The computer program product of claim 15, wherein said marketing information includes information identifying a product or service associated with said sales transaction.

20. The computer program product of claim 15, wherein said marketing information includes information identifying the retailer of a product or service.
